(19) United States
(12) Patent Application Publication
(10) Pub. No.: US 2007/0229233 A1
(43) Pub. Date: Oct. 4, 2007

(54) Reconfigurable tactile-enhanced display including "tap-and-drop" computing system for vision impaired users

(76) Inventor: David Bogart Dort, Arlington, VA (US)

Correspondence Address: VRBIA, INC.;David Dort, Box 26219, Crystal City Station, Arlington, VA, 22215, US

(21) Appl. No.: 11/097,949

(22) Filed: Apr. 2, 2005

Related U.S. Application Data
(60) Provisional application No. 60/522,008, filed on Aug. 2, 2004.
(60) Provisional application No. 60/522,463, filed on Oct. 4, 2004.

(51) Int. Cl. G08B 6/00; G06F 3/041

(52) U.S. Cl. 340/407.1; 345/173

(57) ABSTRACT

The invention has an active touch-sensitive transparent layer over a display screen (LCD) in which an electrically responsive material, such as silicon oil or the above-described material is trapped in a very thin layer with a diode at the top part of the layer and an anode at the bottom. The electrically responsive material changes form by expanding when a current passes through the material from the anode part of the layer to the diode. The expanded material stretches part the top layer to create raised portions of the display screen. The raised portions can be used in the following capacities: to assist a vision impaired viewer, enhance night viewing, allowing for reduced attention or resources to touch-screen manipulation, or change the optical properties of the display by creating a three-dimensional optical property in the surface of the flexible material covering the expanding layer.

### REFERENCE TO PRIORITY DOCUMENTS

This Application claims priority under 35 USC §119(e) to U.S. Provisional Application Ser. No. 60/522,008, filed Aug. 2, 2004, entitled RECONFIGURABLE TACTILE-ENHANCED DISPLAY by John C. Chelen and David Bogart Dort, and also to U.S. Provisional Application Ser. No. 522,403, filed Oct. 4, 2004, entitled TACTILE-BASED FINGER-AS-PEN COMPUTING FOR SIGHT IMPAIRED USERS by David Bogart Dort, both of which are hereby incorporated by reference for all purposes.

### BACKGROUND

Advances in material science have allowed materials that function as a coherent whole or on a miniature (but not necessarily nano or micro scale) materials to obtain properties that have been found from unusual applications. For example, electro-heleological (as well as magneto-heleological, which will only be referred to herein as electro) fluid changes its viscosity when an electric current is passed through it. Thus electro-heleological fluid will stiffen when an electric current is passed through it creating a change in viscosity, which is useful for many industrial applications, including automotive, aerospace and other types of industries.

An electroheleogical fluid has a fast response time of a few milliseconds and can be adjusted in its viscosity in response to a variation in the electric field. Thus, it can be applied in various fields, such as electrically working active suspension systems, valves, brakes, artificial joints and so on.

Electroheleogical phenomenon is associated with a variation in the properties of a suspension which occurs when an external electric field is applied. The fluid shows the same behavior as the usual Newtonian fluid in the absence of the electric field, but it is solidified in the presence of the electrical field and shows a strong flow resistance. A great variation in viscosity occurring in the electroheleogical fluid is due to a variation in the microstructure of a suspension. The application of the electrical field to a static suspension results in the rearrangement of particles in the suspension by the polarization phenomenon occurring within the particles or on their surface, and forms a fibril structure connecting electrodes to each other. Where a strain is applied to the fibril structure of the particles perpendicular to the direction of electric field, the fibril structure is distorted. Energy consumed by this strain causes an increase in viscosity of the suspension. In this case, yield stress of the suspension is increased as the electric field strength is increased. Meanwhile, if the applied shear stress is higher than the yield stress of the fluid, the liquid portion is more fluid. The electroheleogical fluid responds to the electric field in a very fast time of about 10.sup.-3 seconds, or a microsecond (which in the context of display systems is incredibly slow, see the discussion below after FIG. 22) and this response is reversible, so that the electroheleogical fluid can be employed as an excellent medium to transfer electrical signals to mechanical devices. Many mechanical devices have been proposed which use the electroheleogical fluid, including clutches, high speed valves, and vibration-controlling active suspension systems.

Many kinds of dispersion mediums and particles are disclosed as components of the electroheleogical fluid (U.S. Pat. Nos. 3,397,147; 4,483,788; 4,502,973; and 4,668,417). It is generally known that the electroheleogical fluid contains a small amount of water absorbed in particles dispersed therein (less than 10% by weight relative to the particle weight). Thus, by virtue of the ion polarization phenomenon occurring upon the application of the electric field, the electroheleogical fluid exhibits the electroheleogical effect by the formation of a chain structure or by the formation of a water-cross linked structure between the particles.

The electroheleogical activity of this fluid significantly depends on a variation in the water content of the fluid. If this fluid is free of water, it disadvantageously loses its electroheleogical activity and can not be used at high temperature. The fluid, free of water, also has drawbacks from the engineering viewpoint that it results in high abrasion of a machine and is limited in its working temperature. It was recently reported that suspensions having completely dried inorganic or polymeric particles dispersed therein have also occurred the electroheleogical phenomenon. In these suspensions, the dispersed particles are a semiconductor in their electrical property. Additionally, the polarization phenomenon in the application of the electric field occurs by the migration of charge carriers by virtue of their inherent physical and chemical properties of the particles rather than those occurring due to water. U.S. Pat. No. 5,417,874 to Carlson et al. discloses an electroheleogical fluid using inorganic particles of a crystalline lattice structure in which fluid can be worked at a temperature range of 25 to 150.degree. C. However, the disclosed electroheleogical fluid has a drawback in that the dispersed particles are high in their density and thus are easily settled.

Representative polymeric particles dispersed in the non-aqueous electroheleogical fluid include polyaniline particles (See, “The Electroheleogical Properties of Polyaniline Suspensions”, J. Colloidal and Interface Science, Vol. 126, No. 1, April 1990, pp. 175-188). European Patent Publication A 394,005 discloses an electroheleogical effect of a suspension of 30% by volume polyaniline dispersed in a silicone oil. U.S. Pat. Nos. 5,595,680 and 5,437,806 describe non-aqueous electroheleogical fluids using polyanilines and derivatives thereof polymerized from aniline monomers and a mixture of aniline monomers and various monomers.

A dispersion medium of the electroheleogical fluid must have an electrically insulating property and may contain a surfactant to improve its stability. An effective dispersion medium generally needs to have a good dispersibility, a low viscosity and electrical conductivity, a high boiling point, a low freezing point, a chemical stability, and a high dielectric strength. U.S. Pat. No. 4,687,589 discloses physical property values required in the dispersion medium.

Halogenated oil is great in its specific gravity and less in its particle-settling degree, as compared to the conventionally used silicone oil. Also, the halogenated oil may be increased in its electroheleogical activity as compared to the silicone oil, but a precise mechanism for this increase is not known. In the case where additives such as surfactant are included in the halogenated oil, the concentration needs to be limited to such a low degree that it is present only on the particle surface. A chain structure formed by the electric field is necessarily accompanied with the exhibition of the electroheleogical phenomenon, and the shape and thickness of the chain depend on the physical and chemical properties of the components of the fluid. The performance and stability of electroheleogical fluids developed up to now are difficult to meet a stress transfer property required in practical devices, and these fluids thus need to be improved in their performance and stability. Yield stress, a representative property, depends on the applied electric field strength and the particle volume fraction. To achieve a greater yield stress at a realizable electric field strength, increases the particle volume fraction and is effective. However, this particle volume fraction cannot disadvantageously exceed any maximum value, which is varied depending on a viscosity of the dispersion medium, and a shape and surface property of the particles. Moreover, an excessively concentrated dispersion system is excessively high in its viscosity in the absence of the electric field, as well as in the electric current leakage that causes the dielectric breakdown on the application of the large electric field. For this reason, this dispersion system is disadvantageous in that it has insufficient controllability and stability. Thus, a new electroheleogical fluid is required that is not excessively high in its particle concentration while having a high yield stress and an excellent stability.

In addition to the particles suspended in the insulating dispersion medium, an emulsion liquid droplet also undergoes an electrostatic interaction in the presence of the electric field. An article by Pan et al. has reported electroheleogical properties of an emulsion under the electric field (Pan et al., “Characteristics of Electroheleogical Response in an Emulsion System”, J. Colloidal and Interface Science, Vol. 195, No. 1, 1997, pp. 101-113). U.S. Pat. No. 6,645,403 to Park et al entitled, “Multiphase Electroheleogical Fluid” and incorporated by reference herein.

However, consideration of electrically active fluidic materials may also be applied in situations where the change in viscosity may create unusual configurations if harnessed properly. Thus, materials whether electro-heleological or film or sputtered metal foils, or another kind of material that responds to an electrical current or magnetic field and changes configurations either atomically or metalurgically, may find use in devices that could take advantage of the reconfigured material.

The use of expansive and current attractive materials that respond to electrical pulses allows for particular enhancements in tactile-based computational devices. The present invention contemplates several different types or applications of the various materials that change shape, structure, viscosity or other properties based on electrical pulses or currents.

### SUMMARY OF THE INVENTION

The present invention contemplates a comprehensive tactile-based operational and display system for vision impaired users using the expansive and contractive materials in a layer between an electrically conductive sheet and either a finger or other type of circuit completion. The electrical circuit completion by way of the finger or another conductive sheet allows the display to tactically reconfigure through the expansion and contraction of the materials based on electrical signals. Thus, one may think of a “tactile pixel” or tixel™ in which a small portion of a display screen is either raised or lowered or made convex or concave based on specific operations. While in a most complex embodiment, the invention involves a comprehensive input and output system for vision impaired use implementing finger based, or tap and drop computing. There are other applications which are anticipated to be useful within the scope of this invention in areas as diverse as consumer electronics, industrial controls, and manufacturing environments in which display screens may be enhanced with simple tactile-based finger locations to improve performance and reduce operator error.

The particular advantage of the present invention over a simple, permanent and/or not dynamic tactically-enhanced screen such as a cell phone or an industrial control panel is that the present invention teaches a reconfigurable tactile display that is anticipated to act as an input screen as well.

The prior art, which involves touch screens and digitized input screens, is not sufficient to enhance the tactile-based accuracy for the alternative embodiment of the invention. For example, in an industrial setting, a LCD control panel is required for the operation of heavy industrial equipment. The results of pushing the incorrect button may be severe, so the program is executed on the screen such to give the operator a second chance if there is some error which is anticipated. However, this involves extra code and is not necessarily mutually exclusive with the present invention, which simply enhances the screen such that it may be reconfigured each time it is used such that a raised portion maybe in the form of a rectangle or a circle which allows the user to press the right area on the input screen.

The industrial control panel of the display acts as both input and output and is a simple application of the reconfigurable tactile portion of the screen. However, it is not necessary to have a critical manufacturing setting to take advantage of using a tactile-based guide for fingers to find the proper location. For example, in an automotive use, an LCD or LED input screen is utilized by a user in order to set the temperature or program an aspect of an automobile whereby the user would have a tactile enhancement such that while driving they would not be distracted by looking down at the input screen but rather could feel it with their fingers and press on the appropriate spot. One could see that the automotive audio system would be ideal for this particular situation because a driver would not have to look down to make sure they're pressing the correct button or location but, in fact, would rather be able to feel along the tactile enhanced panel and pick the appropriate button. Although, it is anticipated that the simple automotive and industrial use without reconfiguration is not part of the invention, the importance of being able to reconfigure the tactile portion of the screen is critical as it is not necessary to program the same number of selections every time. Thus, the prior art includes a screen with purely static tactile features in which a clear film or plastic may be put over a display screen, but in no way could this screen be reconfigured such that there are six buttons instead of four. Thus the prior art includes a screen with a tactile feature whereas an embodiment of the present invention extends this concept to make the screen reconfigurable. However, the primary embodiment or preferred embodiment of the invention contemplates comprehensive tactile-based computing which is appropriate for vision impaired users. The tactile-based computing system may take advantage of standard Braille or standard English ASCII characters and other shapes and forms which are and have become critical to icon-based computing. A vision-impaired user now may take advantage of the technology such as speech to text, text to speech, Braille keyboards and/or other forms of technology which allows for computing. However, the existing technology is not sufficient: the new invention allows for a vision impaired user to be able to not only make the commands such as voice but also be able to manipulate the icons, text and other computer display components in the same way that a person using a mouse could do.

### BRIEF DESCRIPTION OF THE DRAWINGS

FIG. 1 is a diagram of the prior art LCD touch screen;

FIG. 2 is a simplified “layer” function diagram of a first embodiment of the present invention;

FIG. 3 is a further detailed function diagram of a first embodiment of the present invention;

FIGS. 4A and B show an embodiment of the invention that uses micro-channels and an upper layer of “periodic” flex material allowing for raised and lowered areas;

FIG. 5 shows a function diagram of the electrical current moving the electroheleological fluid to expand the tactile screen;

FIG. 6 shows the implementation in 2 dimensions;

FIG. 7 shows the desired optical manipulation embodiment which may be implemented in conjunction with the tactile-based system or by itself;

FIG. 8 shows an optical distortion and a concave feature in an alternate embodiment.

FIG. 9 shows a sample one dimensional configuration of the tactile screen;

FIG. 10 shows a Braille configuration of the screen in one dimension;

FIG. 11 shows a multiphase embodiment with both raised and lowered portion of the tactile screen.

FIG. 12 shows that an expanding fluidic material is placed in between the screen cover layer and the LCD screen. The electrically active portion may be optionally activated in the same manner as a touchscreen by placing the electrically sensitive layer above the expanding fluidic material.

FIG. 13 shows that an electrical signal is driven to a point below the expanding material, in response the electrical material expands and creates a rise point or section in the cover layer.

FIG. 14A shows the functional diagram of an embodiment in which the tactile section or set of tactile pixels (or TIXEL™ or PICTLE™) is activated at a first point and first time;

FIG. 14B illustrates a second tactile pixel area being activated;

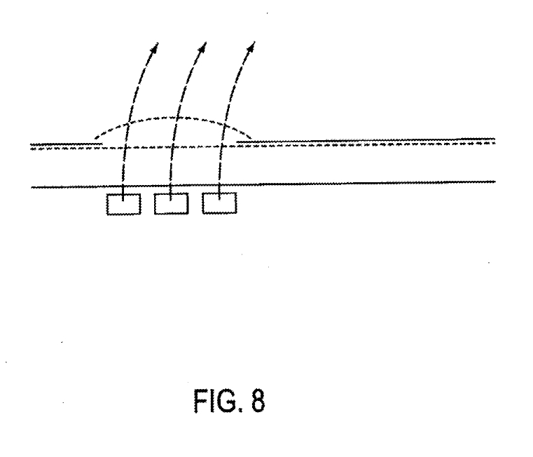

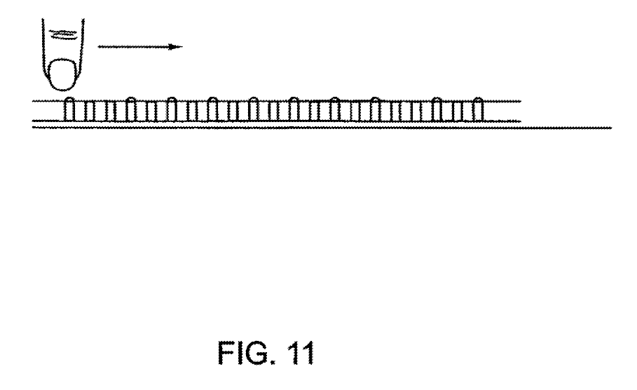

FIGS. 7 and 8 show the optical applications of the present invention in which the “image” is distorted in desired manner applied by the expansion or contraction of the tactile portion of the screen. FIG. 8 also shows the advantage of a concave section (also shown in FIG. 11) of the tactile reconfiguration.

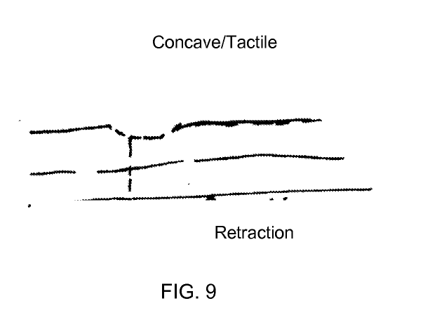

FIG. 9 shows a touch screen in which the tactile portion is also responsive and reconfigured to the touch screen input.

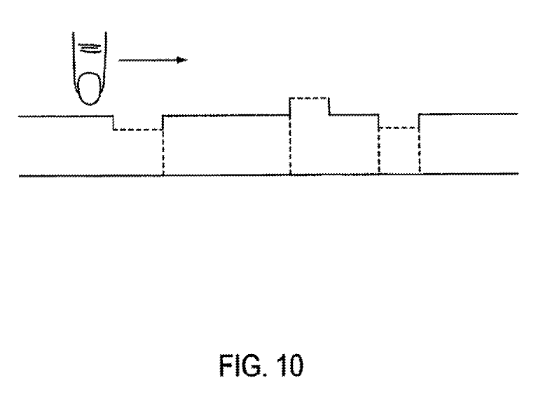

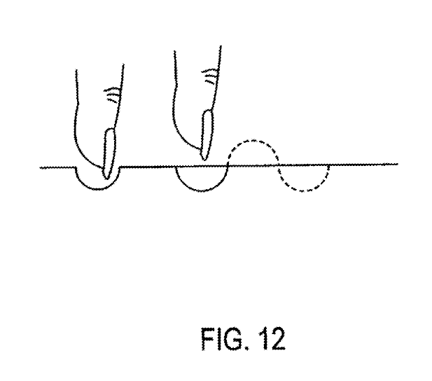

FIG. 10 shows a Braille version of the present invention in which the tactile screen is fully interactive with the finger(s) of the user much in the same manner that a “mouse” or table pen would be available to select menu options and links.

FIG. 15 illustrates a sample tactile-based computing screen and representational functional areas;

FIG. 16 shows a contiguous tactile “font” or a first tactile font type;

FIG. 17 shows a second tactile font type;

FIG. 18 illustrates a sample functional tactile display screen system and the control areas for “tap-and-drop” tactile computing;

FIG. 19 shows a dual function screen in which alpha-numeric and Braille tactile fonts are displayed simultaneously;

FIG. 20 illustrates a sample control activation for various tactile font patterns;

FIG. 21 shows a first embodiment of a tap-and-drop tactile computing system;

FIG. 22 shows the first embodiment in FIG. 21 being activated with a sample shape;

FIG. 23 illustrates a sample control region for tactile-display based computing;

FIG. 24 illustrates another application of the invention in which display areas are reconfigured in a limited tactile-display application;

FIG. 25 illustrates a side view and the advantages of a reconfigurable tactile-enhanced control touch panel;

FIGS. 26A and B show a reconfigured tactile-enhanced touch panel from top and side views.

### DETAILED DESCRIPTION

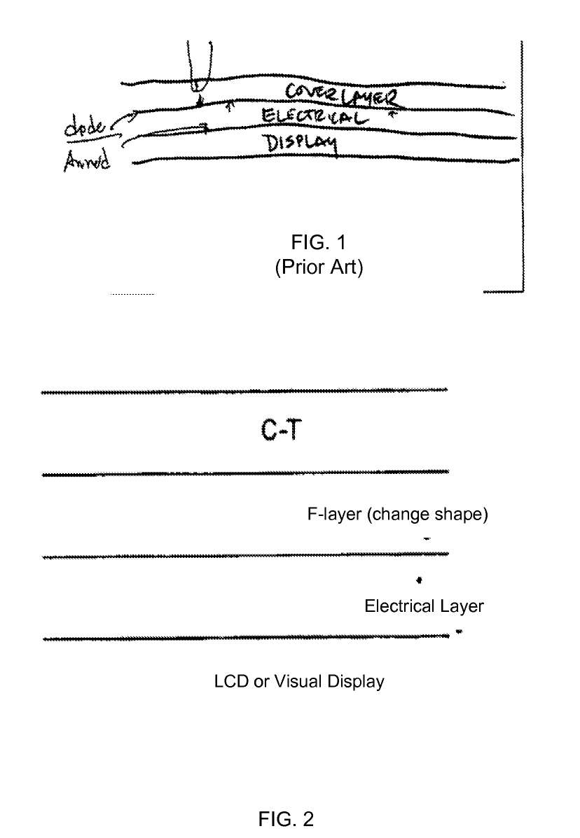

If we refer to FIG. 1, we can understand a very basic concept of the prior art touch screen system, in which a cover layer allows the signals to be processed through touch in order to pass through the electrical layer. The display layer may or may not have any connections to the electrical layer. But, for example, where the finger is touching the cover layer, the electrical layer is responding and may signal the computer to display the appropriate icon or location of this cursor. Of course, the screen layer diagram is a highly simplified version of the many types of prior art and touch screens which can be based on touch, digitizer, such as a pen or other input methods, and are not relevant for purposes of teaching the present invention.

Referring now to FIG. 2, we see the added layer of moveable or electrically moveable material that allows for the present invention to be used in a variety of ways, including the Braille touch screen and/or the tap and drop system. The layers are labeled C-T would be a cover layer and would not be unlike those used in typical prior art touch screens and which are discussed above. The F or shape-changing layer consists of the electrical or magnetically changing fluid/materials which is in of itself a complex science and will be discussed further below. The main thrust of the invention is that by adding the electrically shaped changing layer through its many configurations, the “screen” now becomes a tactically-based screen in which a sight user can have an enhanced computing experience and which a sightless person can use as a sighted person would. The additional layer(s) shown in FIG. 2 are the electrical layer(s), which can have many configurations and will be discussed below. Some of the configurations include the channel style or matrix style touch screen system in which each pixel, or as in the present invention “tixel” tactile pixel, individually and electronically connects the electrically changing layer or F changing layer to the needed electrical impulse. In FIG. 2, the LCD display is shown at the bottom layer, which assumes that this optional feature would be one of the tactically-enhanced embodiments of the invention as opposed to the pure Braille-based version. Of course, there is no reason that a display screen cannot partially have an LCD display beneath the tactile-based computing layers or computing system while other portions simply use the tactile-based system without any display. The advantage of not needing a visual display is apparent: the electrical layer and shape changing layer as well as the cover layer can be made from materials that may not be as translucent as they would be if the display layer needed to be visible, as would be the case in the above discussed prior art type screen shown in FIG. 1.

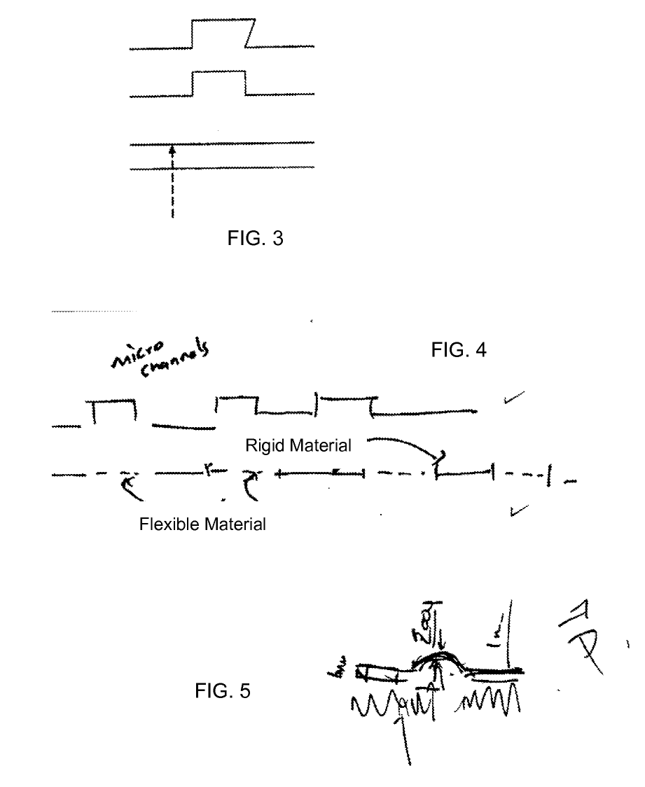

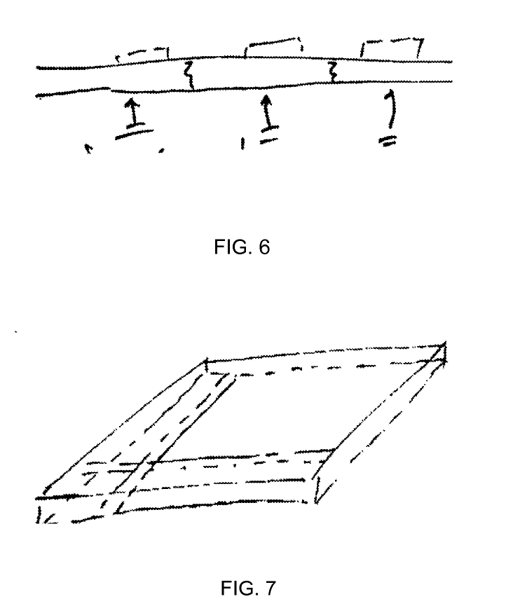

A sample channel system is shown in FIG. 3 in which an electrical pulse, which may be high or low depending on the needs of the manufacturer or end user, is shown through a pulse arrow. The square wave is shown in the fluidic or electro-heleological layer which creates a physical rise in the layer. Above that layer, a tactile-based square, bump or dot, as it may be, embodied in the display screen is actually felt by the user. Of course, this is a very simplified diagram shown in one dimension and may be many configurations and two dimensions. A more detailed version of how the tactile display system may be implemented is shown in FIGS. 4A and 4B through a “micro channel” system, in which a layer of material encompasses the fluidic layer or electro-heleological layer and is actually rigid in certain spots and weakened in other spots. Thus, where the material is shown to be in solid, it will not change shape; however, when the material is shown and dotted in FIG. 4B, the material changes shape creating a micro channel in which certain areas of the surface of the display screen will rise when appropriate electrical pulses are provided to the flexible material medium. For example, in FIG. 4A, there are three raised areas created through electrical pulses to three of the flexible materials. Thus the fourth flexible material area at the end does not have an electrical pulse supplied to it and hence will not raise to the surface layer to create a tactile-based signal or point. FIGS. 4A and B show that the electrically responsive expanding material can be implanted in “channels” (shown in more than one dimension in FIG. 6) and/or be strategic configured underneath specifically configured material in the cover layer, such that the cover layer is easily expanded when the electrical signal is driven.

The electrical pulse or supply system which creates the tactile bumps in the display screen are diagrammatically shown in FIG. 5. The power is supplied to an area or channel in this case, which may be completed by a loop through touch, digitizing pen or a simple circuit in which the channel creates a state in the fluid, which when supplied with a pulse, changes the viscosity or form and hence creates a change in the surface layer. Thus, the three electrical pulses shown with the arrows result in three raised bumps on the surface display.

An example of how the tactile-based display system may be configured in two dimensions is shown in a very simple fashion in FIG. 6 in which two lines of point-based computing, as also shown in FIGS. 4 and 5, could be constructed. Thus a series of points created along two dimensions can easily be imagined by regarding FIG. 6 taking into consideration FIGS. 4 and 5.

Referring now to FIG. 7, an optical distortion embodiment of the display is shown. While the optical distortion system is not anticipated to be particularly useful for vision impaired users, there are many various uses that have optical distortion by either the use of convex or concavity (e.g. the use convex or concave changes in the screen's surface layer) of the surface layer of the screen which may be implemented. Thus, for example, if a particular section of a screen needed magnification, it could be created through convex/concave tactile-based system: the screen would simply respond to the touch of a user and create the signals that change the viscosity in the fluidic layer and raise the layer of the computer screen shown by the arrows.

FIGS. 9 and 10 are illustrative of the Braille capabilities of the present invention. For example, in FIG. 9, a finger is running a single access path in which there are bumps and crevices that correspond to different forms of Braille which also could be shapes, letters, numbers or buttons. As the finger moves along linearly, it may be able to detect particular patterns thus allowing the tactile display to be “read” by the finger.

FIG. 10 is a larger illustration of how a Braille mode implementation of the invention may be used along two axes. Although it is shown in only one axis, a series of pixels are in raised status and a series are in flat status, meaning that they have a certain pattern on the screen which might be read by a finger or two fingers or the like. FIG. 11, however, shows a more complex embodiment of the invention in which the tactile display is “in responsive reconfiguration mode” allowing the user to tactically interact with the screen in a way that may be considered Braille writing or reading, or simply allow the user to respond to the screen with icons. Although the finger shows only a couple of concave and convex portions of the display surface, one could imagine that the screen in two dimensions may be configured in any number of shapes that would enhance a sight-impaired user's ability to exploit the computer. The different configurations could also enhance an LCD screen so that the tactile enhancements could be implemented for other industrial improvements.

In the responsive reconfiguration mode of the invention, the material which responds to the electrical pulses creates a tactile bump or crevice on the display screen and is reconfigurable at a reasonable speed to provide computing capabilities for sight-impaired users. At one end, the panel is simply enhanced by squares. For example, in a simplistic embodiment, the industrial operator puts their finger in the proper location to operate machinery correctly. At the most complex embodiment, a combination of Braille, shapes, figures, letters and custom-designed icons may be presented tactically on the screen at the same time. While FIG. 11 is simply showing a finger running through concave and convex portions of the tactile display screen, it should be noted that parts of the screen are simply responding to the touch of other parts of the screen much in the way that a mouse, cursor, digitizer or other device would be able to do so.

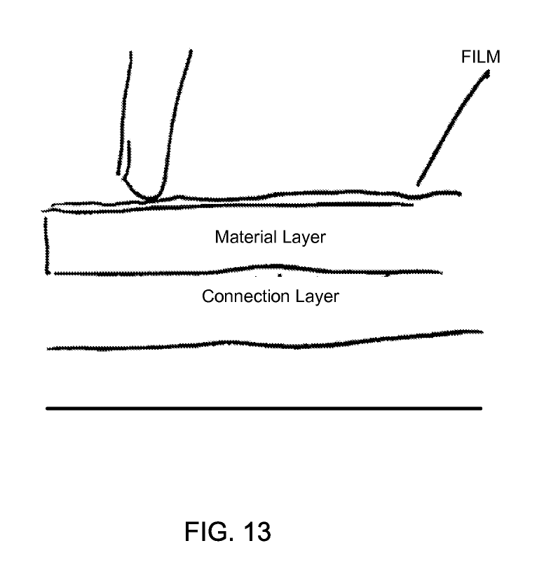

An alternate embodiment of the present invention has an object of taking advantage of the electrical/mechanical properties of the above described electroheleogical materials in order to created an enhanced display screen, including a Braille version for sight-impaired individuals that would also be usable as regular screens. These embodiments are detailed in the description below for FIGS. 13-23.

Referring to FIG. 13, very much like the FIG. 1 shown above, a material layer is coated by a thin film and located above an electrically connective layer. The material layer, which is described above as a material that changes viscosity, shape, or other formation through various electrical and/or electromagnetic signals will cause a raise, a bump, line, square, shape of a type that can be felt by the finger shown running across the film. Thus we can see many different variations of how a non-display or visual display-based computing system could be implemented.

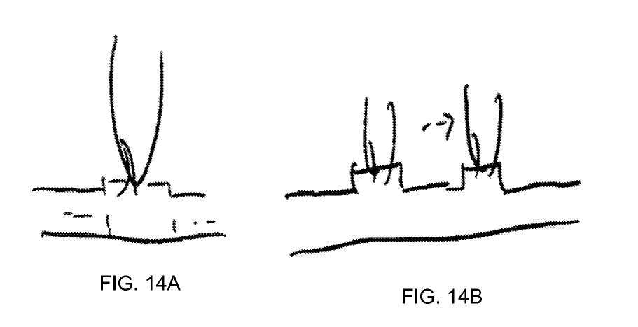

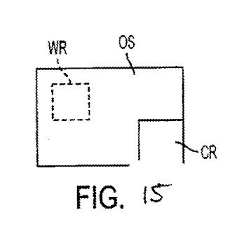

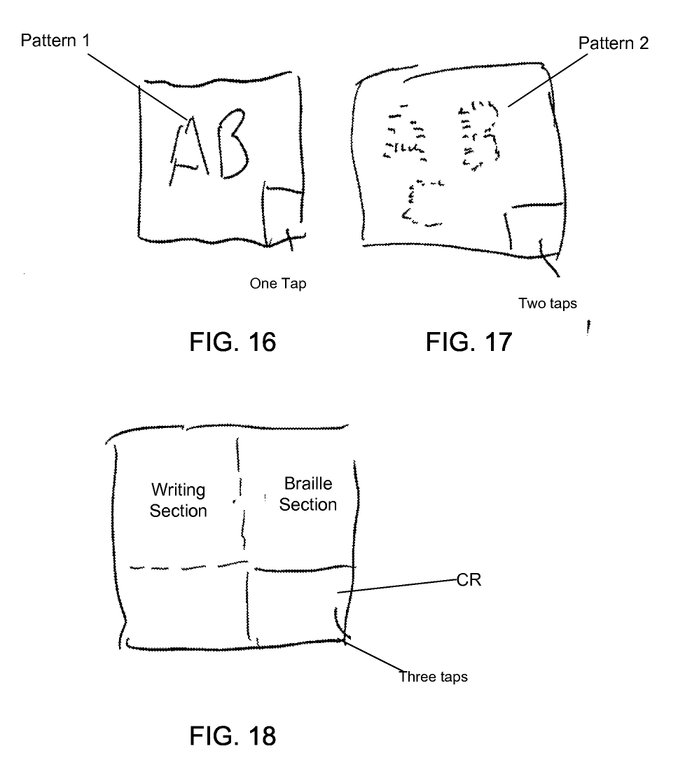

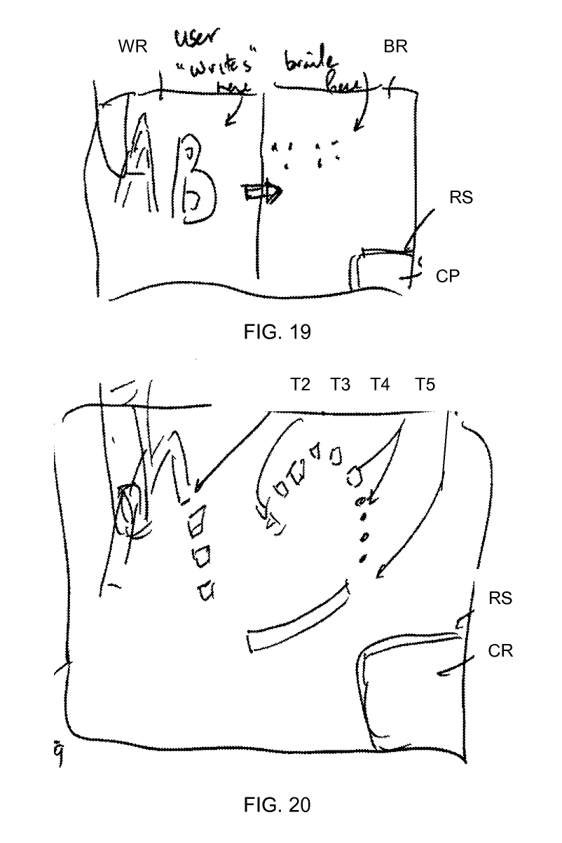

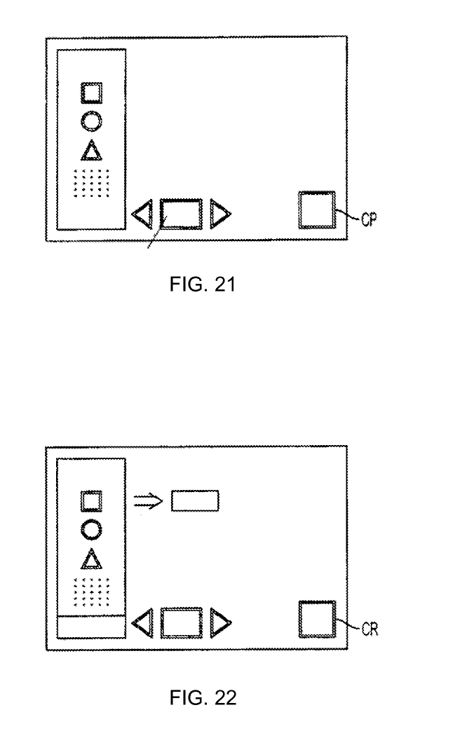

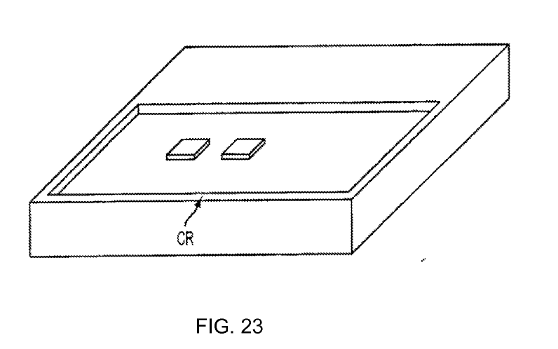

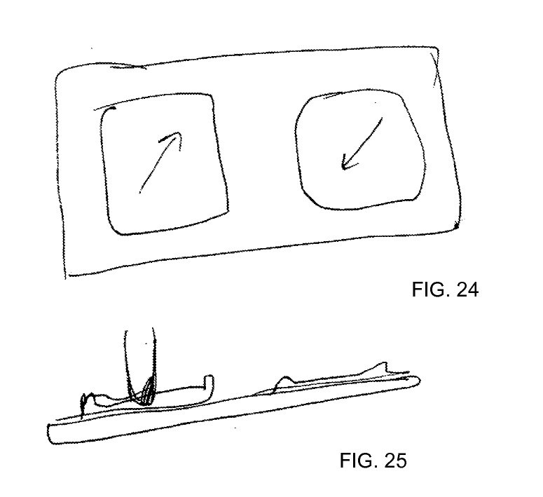

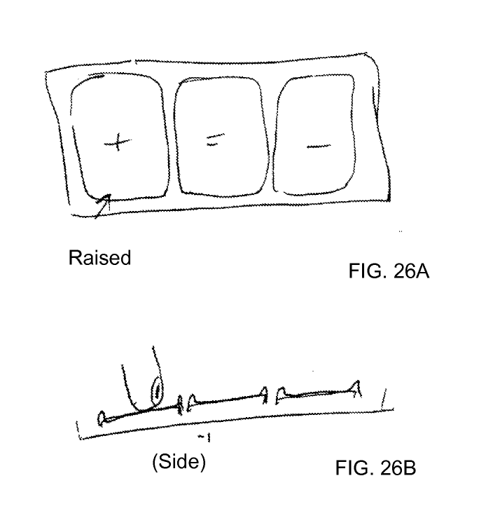

Referring now to FIGS. 14A and 14B, we see a single and double tap system, in which a finger can cause a raise or create a “bubble.” FIG. 14A shows a finger touching the first location and then FIG. 14B shows the finger touching a second location. Thus both locations will have raised portions or “bubbles” in them. In this manner, a display user can configure the tactile-based screen in a way that they desire, even using multiple bubbles or strings of bubbles that create shapes, Braille letters, standard letters, characters or icons of any sort. Of course, the invention is quite different considering this pure tactile screen-based form as compared to a tactile enhanced standard display screen which may or may not have tactile-based bubbles that correspond to display features.

FIG. 15 shows a sample tactile-based operating system marked OS in which there is a control region and a writing region. The writing region is in fact the tactile-based output where the control region may include control-based tactile icons that may not need reconfiguration but act as standard buttons. Thus, a tactile-based user would go to the control region in the lower right portion of the screen to create tactile-based features in the written-based portion of the screen. This provides a single example of how a tactile-based screen or display system may be used but, as can be appreciated, other forms that include some display portions or tactile portions may also be included.

Referring now to FIG. 16, we show that different types of tactile “patterns” or tixels as described above may be based on user preferences. For example, in FIG. 16 a single tap in the control region of the screen may produce smooth-like alphanumeric characters in the tactile form. Thus, the sample A and B would be enhanced or tactically enhanced as the user moved their fingers over them. As shown in FIG. 17, however, two taps may make a different type of pattern. Broken lines or dots can be seen in the display region if the user taps twice in the control region during the appropriate period, thus creating a pattern that is perhaps more recognizable to the sight-impaired user. In this manner, the control region may provide a Braille user the opportunity to simultaneously and tactically write in Braille and alphanumeric characters while being able to check and see if the alphanumeric text is correct based on the Braille pattern.

The multiple-tactile screen can be seen in FIG. 18 in which a tactile screen is divided into different sections that may include an alphanumeric section, a Braille section and a control region. For example, three taps in the control region divides the screen into the writing section in which the pattern would include alphanumeric characters or perhaps include a visual display underneath. The Braille section only uses a tactically enhanced display system such that a sight-impaired user could read Braille of any sort or alphanumeric characters as well as text in Braille or different types of icons. It can be imagined that the complexity of the invention may be made increasingly difficult based on the needs of the end user. However, it is anticipated that in a preferred embodiment, no more than 10 of the display sections including one alphanumeric section, one Braille section and a control region would be necessary because dividing the display screen would be costly during the manufacturing process.

Now referring to FIG. 19, an implementation of the split screen system as implemented in FIG. 18 is shown. For example, a user tactically writes alphanumeric characters in the writing region while in the Braille region corresponding Braille characters appear. In this way, a tactile-based display system may keep the uses of input and output in multiple forms. Consequently, a non-Braille user would be able to write on a screen creating alphanumeric characters that are translated in both raised conventional alpha-numeric characters and Braille. Similarly, the writing region can disappear when the system is being used by only sight impaired or Braille users. This invention also encompasses an embodiment in which the writing region may be both writing region be both tactically used and also used as a digitizer or other kind of touch screen in which writing may be more effective with an input path rather than through the use of a finger. It may also require little, if any, tactile enhancement; however, that does not mean that the invention does not implement the tactile enhanced screen in the Braille region in which Braille or alphanumeric text may appear based on the digitizing input in the writing region.

FIG. 20 shows the different types of patterns based on the taps in the control region, thus different tactile patterns may appear based on user preference. One of the reasons this may be important is that continuous alphanumeric or icon-based characters in a tactically enhanced system are more costly in terms of computation time as opposed to characters that are composed only of portions or bubbles or dots. Thus, the smooth line shown in tap two costs more computational time to display and reconfigure than taps three and four, which are increasingly more sampled and small. A fifth tap returns to the smooth and continuous line that was originally shown in the tactile system. Also shown is a raised bar around the control region that may be reconfigurable or permanent based on the user's needs but would easily be identified by a finger as a region that does not take input in an alphanumeric or Braille sense but rather in a control sense.

FIG. 21 shows a shape based tactile-based computing system or “tap and drop” system screen in which different types of systems that are now implemented in a standard computation system may be implemented in the tactile-based system as well. One sees a next and enter button at the bottom of the screen that may simply ask a forward and backward screen during the reconfiguration of the screen. A legend section shown at the left hand of the screen may provide large amounts of text or symbols for a tactile-based writer or a reader to use or implement into the screen and may include all of alphanumeric text, Braille sections and icon-based computing. This is in addition to the control region, which is still put at the bottom right hand corner of the screen.

FIG. 22 shows a sample operation of the tactile-based or tap-and-drop computing in which a double tap on an icon in the legend section followed by a single tap in the writing region produces a particular shape, character, series of characters, Braille or otherwise. One could also envision a “shape menu” as a substitute for an icon-based menu which may be used in the legend and may be shifted out based on controls. For example, the bottom of the legend section allows a tactile-based user to create their own format, or formats an open shape and adds it to the legend. Thus, commonly used shapes, sets of characters or other menu items that appear in the tactile-written region or reading region can appear on the legend based on user preferences.

Referring now to FIG. 23, a sample cross-section is shown in which the raised section of the screen is set apart from the control region. Thus, a user may allow the control region to have the appropriate size and configuration to their desired width and length. This allows each user, as in a Windows or UNIX-based system to configure their screen such that a control region takes the appropriate and most efficient shape. It should be noted that the continuous movement across the screen will not be efficiently handled because of the “reconfiguration time” of the current electroheleological material is on the order of a microsecond (us). Although, this amount of time would be sufficient for many different applications implementing the present invention, it would also not likely be sufficient to enable visually-impaired users to use robust computing software due to the limitations presented by the input/output of the tactile display system. Therefore the “tap-and-drop” system presents a preferable alternative to the “drag” system due to the conversation of computing resources in reconfiguring the screens.

As discussed above, the invention may also be applied in industrial and consumer areas, where a tactile-enhanced display provides for improved safety and control. This alternate embodiment is shown in its most basic form in FIG. 24, in which two display buttons, illustrated by an “up” and “down” arrows, on a touch panel are “enhanced” by a raised edges. Which are also shown from a side view in FIG. 25, and allow a finger to be easily guided to the correct location on the touch panel, improving control and safety, particularly in situations where a user may be distracted by other safety concerns like in an automobile or industrial setting. The advantage of the present invention in its main embodiment for the enhanced-tactile control screen application, is that it is reconfigurable, allowing any number of screens to be displayed in sequence without the computational device being forced to “render” the display to a pre-configured tactile enhancement. Thus, the reconfigurable tactile enhancements may be used in any application in which it is useful.

FIGS. 26A and B illustrate the reconfigurable advantage of the present invention in which the tactile enhanced displays of FIGS. 24 and 25 are reconfigured to three-button tactile-enhanced touch screens from top and side views in FIGS. 26A and B, respectively.

1-6. (canceled)

7. A computing system for the visually impaired, including:
a processor, power supply operatively connected to said processor;
said power supply also operatively connected to a set of electrical terminals, said set of electrical terminals in electrical contact with a layer of material, said layer of material responsive to electrical signals, such that said material changes physical characteristics when an electrical signal is pulsed high or low at one of said set of electrical terminals, such that a layer of flexible strong film located above said layer of material is raised or lowered accordingly.

8. The computing system for the visually impaired as recited in claim 7, wherein said layer of material is electro-heleological fluid.

9. The computer system for the visually impaired as recited in claim 7, wherein said layer of material is magneto-heleological fluid.

10. The computing system for the visually impaired as recited in claim 7, wherein said flexible film conducts a touch of a finger to complete an electrical signal.

11. The computing system as recited in claim 7, wherein said layer of material is placed in channels.

12. The computing system as recited in claim 11, wherein said outer layer has a different thickness over said channels than in areas not over said channels.

13. An input-output system for a computational system, comprising:
a power supply also operatively connected to a set of electrical terminals, said set of electrical terminals in electrical contact with a layer of material, said layer of material responsive to electrical signals, such that said material changes physical characteristics when an electrical signal is pulsed high or low at one of said set of electrical terminals, such that a layer of flexible strong film located above said layer of material is raised or lowered accordingly and
a set of input terminals in electrical contact with said layer of flexible strong film, configured such that an electrical signal is completed with said terminals when said flexible strong film is touched by a finger.

14. The input-output system for a computational system as recited in claim 13, where said layer of material includes electro-heleological fluid.

15. The input-output system for a computational system as recited in claim 13, where said layer of material includes magneto-heleological fluid.

16. The computing system as recited in claim 13, wherein said layer of material is placed in channels.

17. The computing system as recited in claim 16, wherein said outer layer has a different thickness over said channels than in areas not over said channels.

18. A tactile-enhanced display system for industrial or consumer use, including: an LCD screen, operatively coupled to a processing unit; an outer hour layer comprised of a strong flexible thin film with translucent properties; an intermediate layer comprised of at least two sub-layers, the first sub-layer including a fluidic material capable of changing physical properties when an electric or magnetic pulse is applied to it; said second layer carrying an electrical or magnetic signal to said first layer; and a layer or set of points operatively coupled to said outer thin film layer capable of detecting a user's touch and processing said touch into electrical signals.

19. The tactile-enhanced display system as recited in claim 18, wherein said intermediate layer is only present under said thin film surface and regions in which tactile surface features are desirable.

20. The tactile-enhanced display system as recited in claim 19, wherein said surface features are in the form of rectangles.

21. The tactile-enhanced display system as recited in claim 19, wherein said desirable surface features include circles, triangles, or ellipses.

22. The tactile-enhanced display system as recited in claim 18, wherein said intermediate layer comprising said two sub-layers is present under the entire surface of said thin film layer.

23. The tactile-enhanced display system as recited in claim 18, wherein said first sub-layer including said material is contained in channels.

24. The tactile-enhanced display system as recited in claim 18, wherein said second sub-layer is contained in channels.
